(19) United States
(12) Patent Application Publication
(10) Pub. No.: US 2012/0229075 A1
(43) Pub. Date: Sep. 13, 2012

(54) STRUCTURE OF MULTIPLE-USE ELECTRICAL CHARGER

(76) Inventor: WEI-PO LIAO, Taipei City (TW)

(21) Appl. No.: 13/237,889

(22) Filed: Sep. 20, 2011

(30) Foreign Application Priority Data
Mar. 9, 2011 (TW) 100204119

(51) Int. Cl. H02J 7/00

(52) U.S. Cl. 320/107

(57) ABSTRACT

A structure of multiple-use electrical charger includes a transformer, which has an end to which a USB connector is attached and an opposite end to which a charging cable is attached, a charging cable, which has two ends each of which is provided with a probe pin and fused with a silicone rubber member for looping around a battery to carry out electrical charging operation; and a battery, which includes metal plates for engagement with the probe pins of the charging cable for carrying out electrical charging operation. With the charging cable being provided with the probe pins and the silicone rubbers, in use, the probe pins of the charging cable are respectively put in alignment with metal plates of the battery and the silicone rubbers are looped around the battery, so that engagement between the probe pins and the metal plates of the battery are made tight.

### TECHNICAL FIELD OF THE INVENTION

The present invention generally relates to an improved structure of electrical charger, and more particularly to an improved structure of multiple-use electrical charger comprising a charging cable that is provided with probe pins and silicone rubber members so that through the resilient features provided by the probe pins and the silicone rubber members, tight and precise engagement with contact metal plates of various modes of electrical battery can be made for realizing excellent charging operation, wherein such an arrangement is of a simple structure, is easy to operate, and is practical.

### DESCRIPTION OF THE PRIOR ART

A conventional electrical charger adopts a spring plate structure for carrying out electrical charging operation with respect to a battery. Since the engagement between the spring plate and metal contact plates of the battery is often not precise and tight, electrical shorting often occurs, leading to shortening of the lifespan of battery. It is thus desired to overcome the problem that the lifespan of a battery is shortened by the damage caused on the battery by the conventional electrical charger.

### SUMMARY OF THE INVENTION

In view of the above described problem of the conventional techniques, the present invention aims to overcome the problems of the conventional techniques by providing an improved structure of electrical charger, of which a primary objective is to effectively overcome the problem that the lifespan of a battery is shortened by the damage caused on the battery by the conventional electrical charger and thus makes the present invention practical. Through the arrangement that a charging cable is provided with probe pins and silicone rubber members and with the resilient features provided by the probe pins and the silicone rubber members, tight and precise engagement with contact metal plates of various modes of electrical battery can be made for realizing excellent charging operation, wherein such an arrangement is of a simple structure, is easy to operate, and is practical.

To achieve the above objective, the present invention provides a structure of multiple-use electrical charger, which comprises: a transformer, which has an end to which a USB (Universal Serial Bus) connector is attached and an opposite end to which a charging cable is attached; and a charging cable, which has two ends each of which is provided with a probe pin and fused with a silicone rubber member for looping around a battery to carry out electrical charging operation; wherein with the charging cable being provided with the probe pins and the silicone rubbers, in use, the probe pins of the charging cable are respectively put in alignment with metal plates of the battery and the silicone rubbers are looped around the battery, whereby since the probe pins and the silicone rubbers feature excellent resiliency, engagement between the probe pins and the metal plates of the battery are made tight to thereby realize excellent effect of electrical charging, further, the USB connector being plugged into a computer to carry out electrical charging, such an arrangement being of a simple structure, being easy to operate, and being practical.

Another objective the present invention is to provide, at each end of the charging cable, a spring plate that cooperates with a silicone rubber member to realize better fitting engagement with the battery for carrying out electrical charging operation.

A further objective the present invention is to provide, at each end of the charging cable, a rubber member to cooperate with the probe pin for realizing electrical charging operation.

A further objective the present invention is to provide, at one end of the transformer, a power plug for direct plugging into a power socket for carrying out electrical charging operation.

Yet a further objective of the present invention is to provide an electrical charger comprising a transformer that is a smart transformer capable of automatic identification of electrical polarities, so that the charging cable is made versatile in practical operation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is an assembled view of the present invention.

FIG. 3 is a schematic view illustrating the use of the present invention.

FIG. 4 is a perspective view illustrating another embodiment of the present invention.

FIG. 5 is a perspective view illustrating a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Structure and features of the present invention will be readily apparent from the following description of preferred embodiments thereof with reference to the drawings.

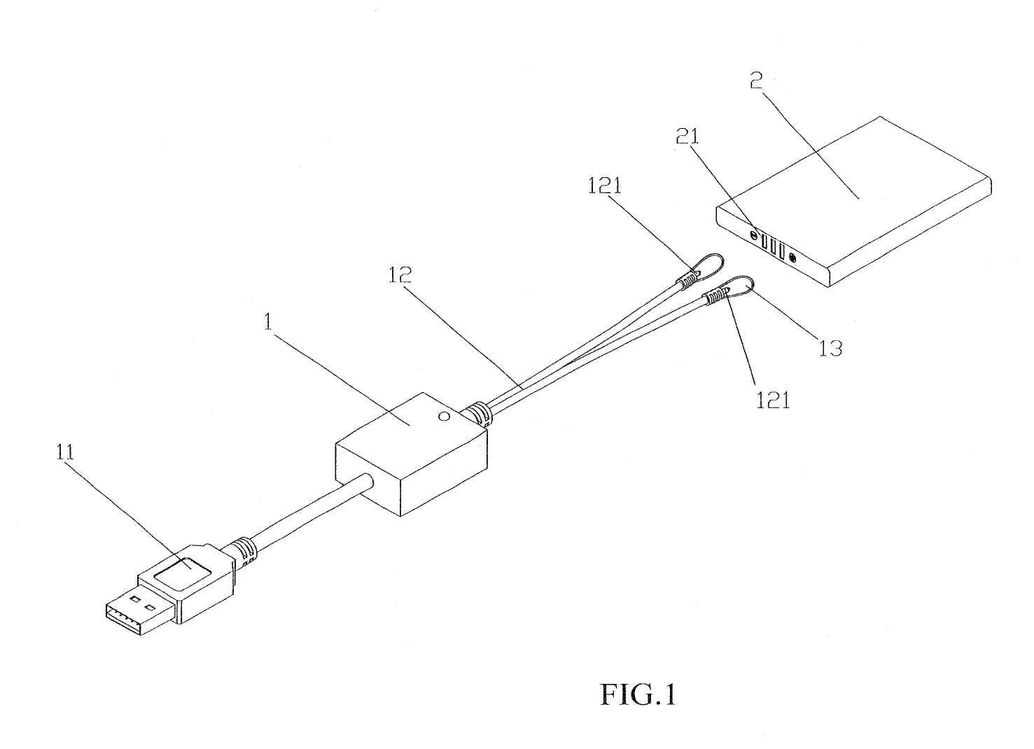

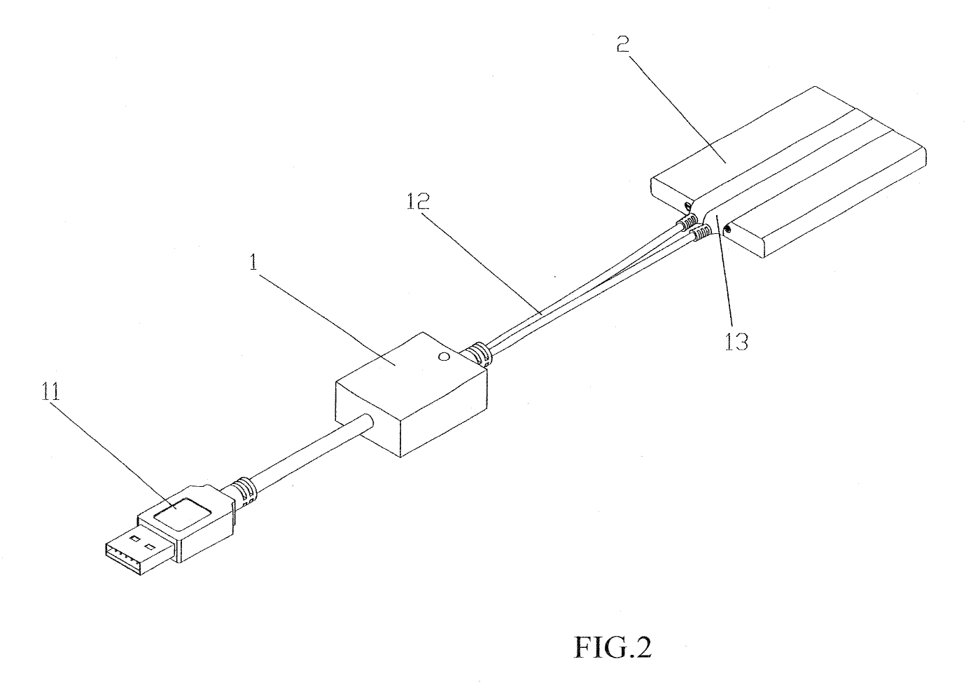

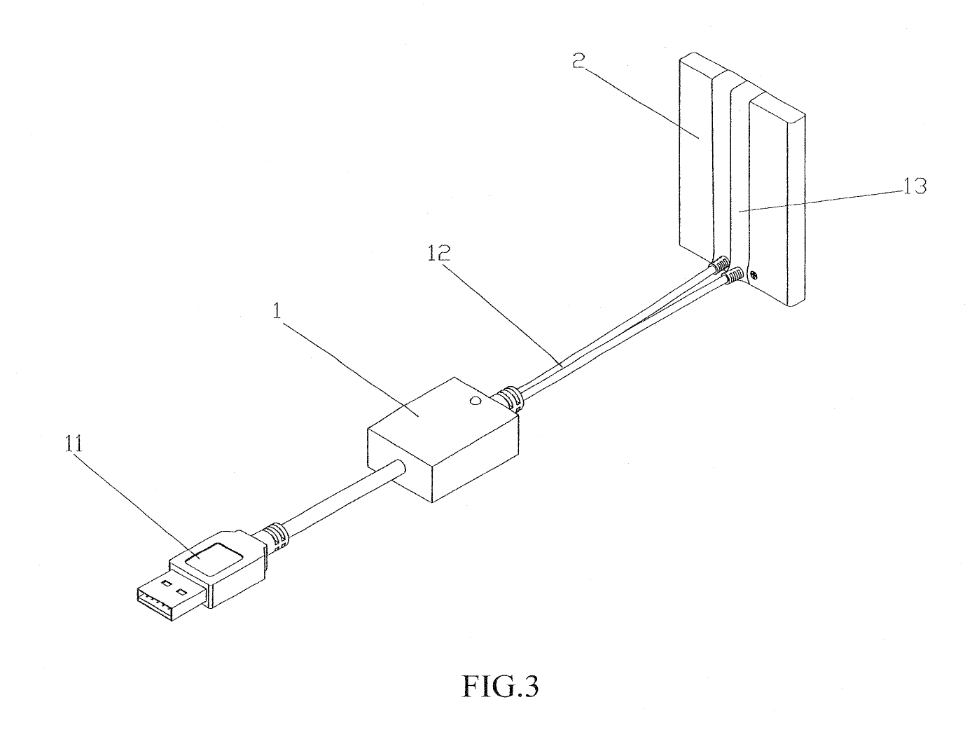

As shown in FIGS. 1-3, the present invention provides a structure of multiple-use electrical charger, which comprises the following components:

A transformer 1 has an end to which a USB (Universal Serial Bus) connector 11 is attached and an opposite end to which a charging cable 12 is attached.

The charging cable 12 has two ends which are each provided with a probe pin 121 and fused with a silicone rubber member 13 for looping around the battery 2 to carry out electrical charging operation.

A battery 2 is provided with metal plates 21 that are engageable with the probe pins 121 of the charging cable 12 for performing electrical charging operation.

With the charging cable 12 being provided with the probe pins 121 and the silicone rubbers 13, in use, the probe pins 121 of the charging cable 12 are respectively put in alignment with the metal plates 21 of the battery 2 and the silicone rubbers 13 are looped around the battery. Since the probe pins 121 and the silicone rubbers 13 feature excellent resiliency, the engagement between the probe pins 121 and the metal plates 21 of the battery 2 are made tight to thereby realize excellent effect of electrical charging. Finally, the USB connector 11 is plugged into a computer to carry out electrical charging. This arrangement is of a simple structure, is easy to operate, and is practical.

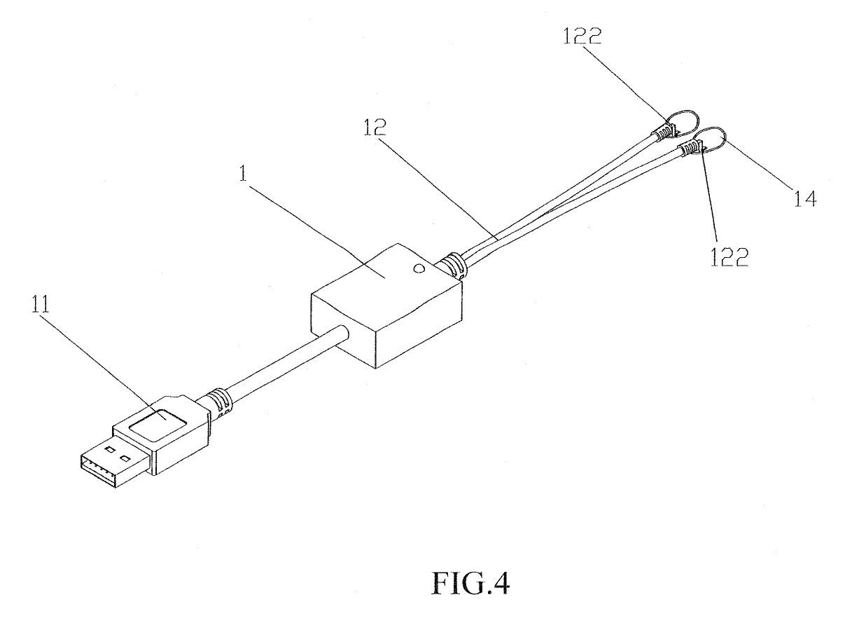

Another objective of the present invention (as shown in FIG. 4) is to provide at each end of the charging cable 12 a spring plate 122 that cooperates with a silicone rubber member 13 to realize better fitting engagement with the battery 2 for carrying out electrical charging operation.

A further objective the present invention (as shown in FIG. 4) is to provide, at each end of the charging cable 12, a rubber member 14 to cooperate with the probe pin 121 for realizing electrical charging operation.

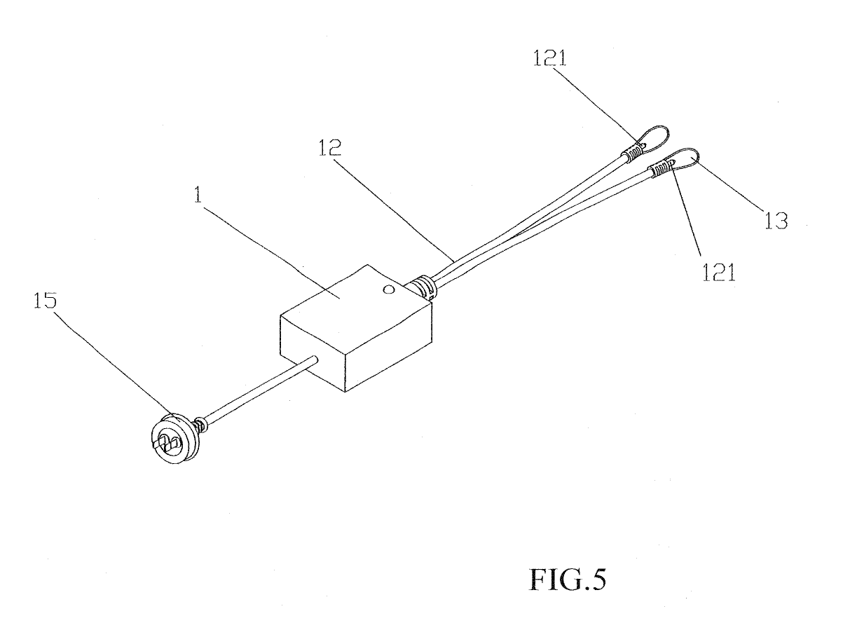

A further objective the present invention (as shown in FIG. 5) is to provide, at one end of the transformer 1, a power plug 15 for direct plugging into a power socket for carrying out electrical charging operation.

Yet a further objective of the present invention is to provide an electrical charger comprising a transformer 1 that is a smart transformer capable of automatic identification of electrical polarities, so that the charging cable is made versatile in practical operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of multiple-use electrical charger, comprising:
a transformer, which has an end to which a USB (Universal Serial Bus) connector is attached and an opposite end to which a charging cable is attached; and
a charging cable, which has two ends each of which is provided with a probe pin and fused with a silicone rubber member for looping around a battery to carry out electrical charging operation;
wherein with the charging cable being provided with the probe pins and the silicone rubbers, in use, the probe pins of the charging cable are respectively put in alignment with metal plates of the battery and the silicone rubbers are looped around the battery, whereby since the probe pins and the silicone rubbers feature excellent resiliency, engagement between the probe pins and the metal plates of the battery are made tight to thereby realize excellent effect of electrical charging, further, the USB connector being plugged into a computer to carry out electrical charging, such an arrangement being of a simple structure, being easy to operate, and being practical.

2. The structure of multiple-use electrical charger according to claim 1, wherein an end of the charging cable is provided with a spring plate that cooperates with a silicone rubber member to realize better fitting engagement with the battery for carrying out electrical charging operation.

3. The structure of multiple-use electrical charger according to claim 1, wherein an end of the charging cable is provided with a rubber member to cooperate with the probe pin for realizing electrical charging operation.

4. The structure of multiple-use electrical charger according to claim 1, wherein one end of the transformer is provided with a power plug adapted to directly plug into a power socket for carrying out electrical charging operation.

5. The structure of multiple-use electrical charger according to claim 1, wherein the transformer is a smart transformer that realizes automatic identification of electrical polarities, so that the charging cable is made versatile in practical operation.
